(19) United States
(12) Patent Application Publication
(10) Pub. No.: US 2013/0159487 A1
(43) Pub. Date: Jun. 20, 2013

(54) Migration of Virtual IP Addresses in a Failover Cluster

(71) Applicants: Parveen Kumar Patel, Redmond, WA (US); David A. Dion, Bothell, WA (US); Corey Sanders, Redmond, WA (US); Santosh Balasubramanian, Seattle, WA (US); Deepak Bansal, Sammamish, WA (US); Vladimir Petter, Bellevue, WA (US); Daniel Brown Benediktson, Seattle, WA (US)

(72) Inventors: Parveen Kumar Patel, Redmond, WA (US); David A. Dion, Bothell, WA (US); Corey Sanders, Redmond, WA (US); Santosh Balasubramanian, Seattle, WA (US); Deepak Bansal, Sammamish, WA (US); Vladimir Petter, Bellevue, WA (US); Daniel Brown Benediktson, Seattle, WA (US)

(73) Assignee: MICROSOFT CORPORATION, Redmond, WA (US)

(21) Appl. No.: 13/415,844

(22) Filed: Mar. 9, 2012

Related U.S. Application Data
(60) Provisional application No. 61/570,819, filed on Dec. 14, 2011.

(51) Int. Cl. G06F 15/173

(52) U.S. Cl. 709/223; 709/238

(57) ABSTRACT

The movement of a Virtual IP (VIP) address from cluster node to cluster node is coordinated via a load balancer. All or a subset of the nodes in a load balancer cluster may be configured as possible hosts for the VIP. The load balancer directs VIP traffic to the Dedicated IP (DIP) address for the cluster node that responds affirmatively to periodic health probe messages. In this way, a VIP failover is executed when a first node stops responding to probe messages, and a second node starts to respond to the periodic health probe messages. In response to an affirmative probe response from a new node, the load balancer immediately directs the VIP traffic to the new node's DIP. The probe messages may be configured to identify which nodes are currently responding affirmatively to probes to assist the nodes in determining when to execute a failover.

### CROSS-REFERENCE TO RELATED APPLICATIONS

The present application claims the benefit of the filing date of U.S. Provisional Patent Application No. 61/570,819, which is titled “Migration of Virtual IP Addresses in a Failover Cluster” and filed Dec. 14, 2011, the disclosure of which is hereby incorporated by reference herein in its entirety.

### BACKGROUND

Infrastructure as a Service (IaaS) provides computing infrastructure resources, such as server resources that provide compute capability, network resources that provide communications capability between server resources and the outside world, and storage capability that provides persistent data storage. IaaS offers scalable, on-demand infrastructure that allows subscribers to use resources, such as compute power, memory, and storage, only when needed. The subscriber has access to all the capacity that might be needed at any time without requiring the installation of new equipment. One use of IaaS is, for example, a cloud-based data center.

In a typical IaaS installation, the subscriber provides a virtual machine (VM) image that is hosted on one of the IaaS provider's servers. The subscriber's application is associated with the IP address of the VM. If the VM or host fails, a backup VM may be activated on the same or a different host to support the application if the subscriber has configured such a backup. The IP address for the subscriber's application would also need to be moved to new VM that takes over the application. Thereafter, client applications that were accessing the subscriber's application can still find the subscriber's application using the same IP address even though the application has moved to a new VM and/or host.

Problems arise when IaaS is provided in the cloud environment. As noted above, the client application must find the new VM and/or host following a failover from an original VM/host. In the cloud environment, each VM typically has a limited number of IP addresses. The IaaS infrastructure may be constrained against arbitrarily moving an IP address from one VM to another VM or for one machine to have multiple IP addresses. Additionally, the cloud environment may not allow for an IP to move between nodes. As a result, if the subscriber's application is moved to a new VM and/or host following failover, client applications would have to be notified of a new IP address to find the new VM and/or host.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The movement of a Virtual IP (VIP) address from server instance to server instance is coordinated via a load balancer. The server instances form nodes in a load balancer cluster. In one embodiment, a load balancer forwards traffic to the nodes. All or a subset of the nodes in a load balancer cluster may be configured as possible hosts for the VIP. The load balancer directs VIP traffic to the cluster node that responds affirmatively to periodic health probe messages. The traffic may be directed to a Dedicated IP (DIP) address for the cluster node or using some other mechanism for directing traffic to the appropriate node. In this way, a VIP failover is executed when a first node stops responding to probe messages, and a second node starts to respond to the periodic health probe messages. In response to an affirmative probe response from a new node, the load balancer immediately directs the VIP traffic to the new node's DIP. The probe messages may be configured to identify which nodes are currently responding affirmatively to probes to assist the nodes in determining when to execute a failover.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a load balancer hosting a VIP in failover cluster according to one embodiment;

FIG. 2 illustrates a failover cluster using a load balancer to host a VIP according to an alternative embodiment;

FIG. 3 illustrates an alternative embodiment of a failover cluster in which the load balancer is not in the direct traffic path to the host servers and VMs;

FIG. 4 illustrates a failover cluster using network load balancing distributed across multiple nodes according to a one embodiment;

FIG. 5 illustrates a load balancer hosting a VIP in failover cluster in an alternative local area network embodiment;

FIG. 6 is a flowchart illustrating a process for routing packets in a failover cluster according to one embodiment;

FIG. 7 is a flowchart illustrating a process for routing packets in a failover cluster according to another embodiment; and

FIG. 8 is a block diagram illustrates an example of a computing and networking environment on which the embodiments described herein may be implemented.

### DETAILED DESCRIPTION

Clients connect to applications and services in a failover cluster using a “virtual” IP address (VIP). The VIP is “virtual” because it can move from node to node, for instance in response to a failure, but the client does not need to be aware of where the VIP is currently hosted. This is in contrast to a dedicated IP address (DIP), which is assigned to a single node. In cloud/hosted network infrastructures, the typical LAN/Ethernet mechanisms that facilitate moving VIPs from node to node do not exist, because the network infrastructure itself is fully virtualized. Therefore, a different approach to moving VIPs from node to node is required.

In one embodiment, the movement of a VIP from node to node in a failover cluster is coordinated via a load balancer. For example, a set of nodes may be configured as possible hosts for a particular subscriber application. Each of the nodes has a corresponding DIP. A load balancer that is assigned the VIP is used to access the nodes. The load balancer maps the VIP to the DIPs of the nodes in the failover cluster. In other embodiments, the load balancer may map the VIP to a subset of the cluster nodes, if, for example, the workload represented by the VIP is not potentially hosted on all nodes in the cluster. In additional embodiments, the nodes are assigned some other identifier other than a DIP, such as a Media Access Control (MAC) address or some network identifier, and the VIP is mapped to that other (i.e. non-DIP) form of identifier.

The load balancer directs traffic destined to the VIP only to the one specific cluster node that is currently assigned to host the subscriber's application. The assigned node notifies the load balancer that it is hosting the subscriber application by responding affirmatively to periodic health probe messages from the load balancer. A VIP failover or reassignment may be executed by having a first node stop responding to health probe messages, and then having a second node start to respond to the periodic probe messages. When the load balancer identifies the new health probe response from the second node, it will route traffic associated with the VIP to the second node. In other embodiments, instead of waiting for a health probe or heartbeat message from the load balancer, the second node may proactively inform the load balancer that all traffic for the VIP should now be directed to the second node.

In one embodiment, no special permission is required by the application or the VM to respond to the health probe or to configure the load balancer. From the perspective of the load balancer, the application and the probed VM are untrusted. Alternatively, the nodes and/or subscriber applications may be assigned different levels of trust and corresponding levels of access to the load balancer. For example, an application with a high trust level and proper access may be allowed to reprogram the load balancer, such as by modifying the VIP mapping on the load balancer. In other embodiments, applications with low levels of trust may be limited to sending the load balancer responses to health probes, which responses are then used by the load balancer to determine which node should receive the VIP traffic.

The failover process may be further optimized by making the load balancer be aware that the VIP should be hosted on only one node at a time. Accordingly, in response to receiving an affirmative probe response from a new node, the load balancer immediately directs the VIP traffic to the new node. Once the new node has taken responsibility for the application, the load balancer stops directing traffic to the old node, which had previously sent affirmative responses, but is no longer hosting the application.

The health probe messages may be also be enhanced by notifying the other nodes in the cluster which node or nodes are currently responding affirmatively to probes. This can assist the nodes in determining when to execute a failover. For example, if the load balancer starts reporting via its probes that no node is responding affirmatively, then a different node in the cluster can take over.

In other embodiments, the load balancer capabilities may support multiple VIPs per cluster of nodes. This allows multiple applications to be hosted simultaneously by the cluster. Each application may be accessed by a separate VIP. Additionally, each application may run on a different subset of the cluster nodes.

The VIP may be added to the network stack on the node where it is currently hosted so that clustered applications may bind to it. This allows the applications to send and receive traffic using the VIP. The load balancing infrastructure conveys the packets from the node to and from the load balancer. The packets may be conveyed using encapsulation, for example.

Although the solution is described in some embodiments as designed for interoperability with a failover cluster, the same techniques may be applied to other services that require VIPs to move among IaaS VM instances.

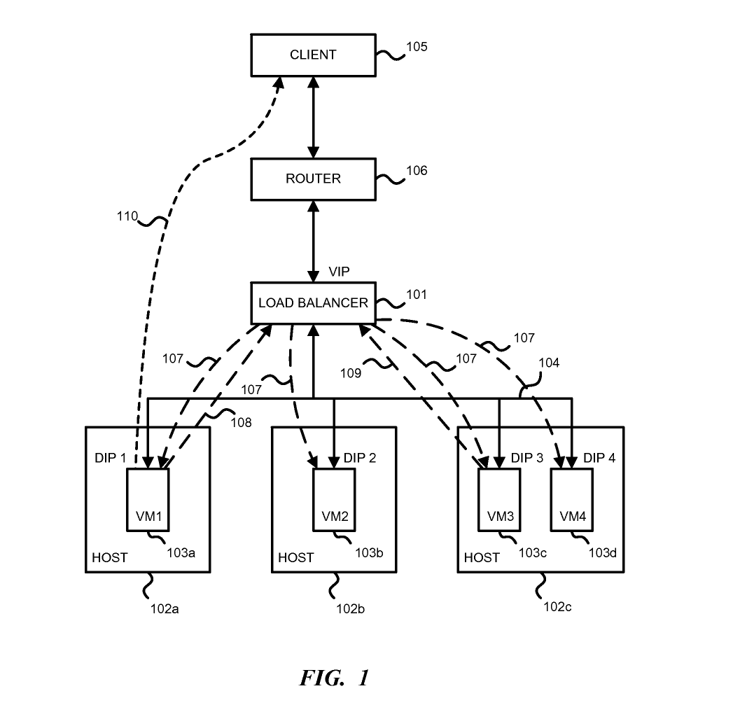

FIG. 1 illustrates a load balancer 101 hosting a VIP in failover cluster according to one embodiment. A plurality of VMs 103 represents the nodes in the failover cluster. Hosts 102 support one or more virtual machines (VM) 103. Hosts 102 may be co-located, or two or more hosts 102 may be distributed to different physical locations. Load balancer 101 communicates with the VMs 103 via network 104, which may be the Internet, an intranet, or a proprietary network, for example.

VMs 103 are each assigned a unique DIP. Load balancer 101 maps the VIP to all of the DIPs. For example, in FIG. 1, VIP maps to: DIP1; DIP2; DIP3; DIP4. Load balancer 101 keeps track of which VM 103 is currently active for the VIP. All traffic addressed to the VIP is routed by the load balancer 101 to the DIP that corresponds to the currently active VM 103 for that VIP. For example, a client 105 sends packets addressed to the VIP. One or more routers 106 direct the packets to load balancer 101, which is hosting the VIP. Using the VIP:DIP mapping, load balancer 101 directs the packets to the VM 103 that is currently hosting the application. The active VM 103 then communicates back to client 105 via load balancer 101 so that the return packets appear to come from the VIP address.

Load balancer 101 uses probe messages, such as health queries, to keep track of which VM 103 is currently active and handling the subscriber's application. For example, if the subscriber's application is currently running on VM1 103a, then when load balancer 101 sends probe messages 107, only VM1 103a responds with a message 108 that indicates that it is healthy and responsible for the subscriber's application. The other VMs either do not respond to the health probe (e.g. VM2 103b; VM4 103d) or respond with a response message 109 that indicates poor health for VM3 (e.g. VM3 103c). Load balancer 101 continues to forward all traffic that is addressed to the application's VIP address to the DIP 1 address for VM1 103a. Load balancer 101 continues to issue periodic health probes 107 to monitor the health and status VMs 103.

If VM1 103a or host 102a fail or can no longer support the subscriber's application, then VM1 103a responds to health probe message 107 with a message 108 that indicates such a failure or other problem. Alternatively, VM1 103a may not respond at all, and load balancer 101 detects the failure due to timeout. The VMs 103 communicate with each other to establish which node has the responsibility for the application and then communicate that decision back to the load balancer via an affirmative health probe response from the responsible VM 103. In the fast failover case, the other nodes (i.e. VMs 103b, 103c, 103d) may detect a failure in the application or in VM 103a before the load balancer has sent a health probe, and a different node (e.g. VM 103c) may send an affirmative health probe to the load balancer before it detects the failure of the old VM 103a. For example, when VM1 103a fails, if VMs 103 determine that VM3 103c now has the responsibility for the application, then VM3 103c sends an affirmative health probe response. All future VIP traffic is then directed to DIP3 at VM3 103c. In response to future health probe messages 107, VM3 103c responds with message 109 to indicate that it is healthy, operating properly, and responsible for the subscriber's application.

In other embodiments, upon failure of VM1 103a, load balancer 101 may use heath probe messages 107 to notify the remaining VMs 103b-d that the subscriber application is currently unsupported. One of the remaining VMs 103b-d, such as an assigned backup or a first VM to respond, then takes over for the failed VM1 103a by sending a health probe response message to load balancer 101, which then routes the VIP traffic to the DIP for the new VM.

Such a method may also be used proactively without waiting for health probe message 107. VM1 and VM3 may communicate directly with each other, for example, if VM1 recognizes that it is failing or otherwise unable to support the application. VM1 may notify backup VM3 that it should take responsibility for the application. Once the application is active on VM3, then an unprompted message 109 may be sent to load balancer 101 to indicate that VM3 should receive all of the VIP traffic.

Load balancer 101 may also host multiple VIPs that are each mapped to different groups of DIPs. For example, a VIP1 may be mapped to DIP1 and DIP3, and a VIP2 may be mapped to DIP2 and DIP4. In this configuration, all of the nodes or VMs in the failover cluster do not have to support or act as backup to all of the hosted applications.

Software in the VMs 103 or host machines 102 may add the VIP and/or DIP addresses to the VM's stack for use by the application. In one embodiment, each of the VMs 103 is assigned a unique DIP. The VIP is also added to the operating system on the VM where the application is currently hosted so that clustered applications can bind to the VIP, which allows the node to send and receive traffic using the VIP. When the VM1 103a operating system has the VIP address, then the application may bind to the VIP and may respond directly to client 105 with message 110 without passing back through load balancer 101. Message 110 originates from device VM1 103a, which is assigned both the DIP1 and the VIP address. This allows the application to use direct server return to send packets to the client 105 while having the proper source VIP address in the packets. Similarly, the operating systems for the other VMs 103 may have both the VIP and DIP addresses, which allows applications on any of the VMs to use direct server return.

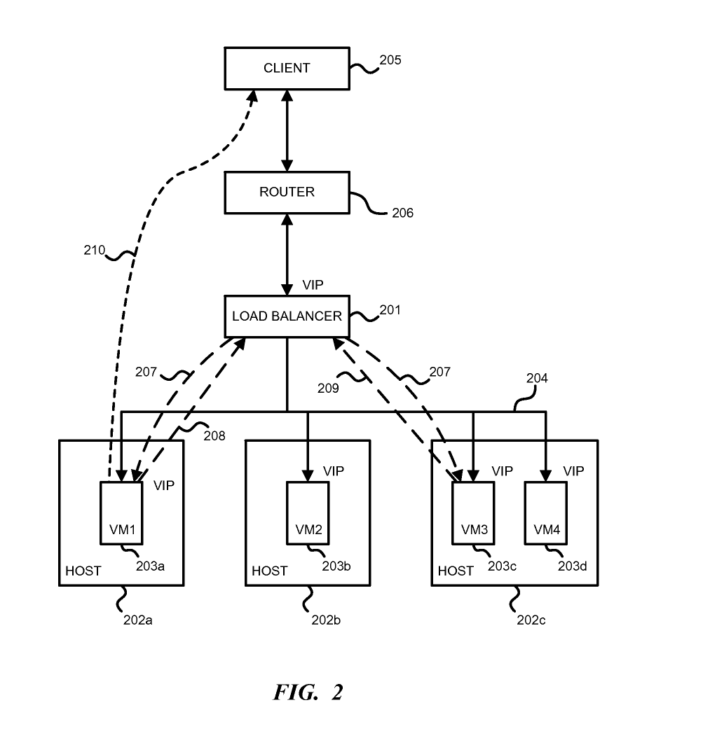

FIG. 2 illustrates a failover cluster using load balancer 201 to host a VIP according to an alternative embodiment. Host servers 202 support one or more VMs 203. Instead of being assigned different DIPs, each of the VMs 203 are assigned the same VIP address for the subscriber application. However, only one of the VMs 203 is actively supporting the application at any time. The other VMs 203 are in a standby or backup mode and do not respond to any traffic directed to the VIP address from the load balancer 201 over network 204. Packets addressed to the VIP from client 205 are routed through one or more routers 206 to load balancer 201, which exposes the VIP outside of the failover cluster.

Load balancer 201 continues to issue health probe messages 207 to all of the VMs 203. The VM1 203a that is currently supporting the subscriber application responds with a health status message 208 that acknowledges ownership of the application. Other VMs, such as VM3 203c, may respond to the health probe message 207 with a negative health message 209 that notifies load balancer 201 that it is not currently supporting the application. To simplify FIG. 2, health probe messages 207 are illustrated only between load balancer 201 and VMs 203a,c. However, it will be understood that health probe messages 207 are sent by load balancer 201 to all of the VMs 203.

VMs 203 are assigned the VIP address, and, as a result, the host VM1 203a may respond directly to client 205 with message 210 without passing back through load balancer 201. Message 210 originates from a device VM1 203a that is assigned the VIP address, which allows it to use direct server return to send packets to the client 205 while having the proper source VIP address in the packets.

If VM1 203a fails, then a backup VM3 203c may take over the subscriber application. VM3 203c may issue a health response message 209 to load balancer 201 proactively upon observing that VM1 203a has not responded to a routine health probe 207. Alternatively, VM3 203c may issue response message 209 in response to a health probe 207 that indicates that the subscriber application is not currently supported by any VM. Once the new VM3 203c takes over the application, load balancer 201 routes incoming VIP packets to VM3 and/or the other VMs 203 each ignore the VIP packets because they are not currently assigned to the subscriber's application.

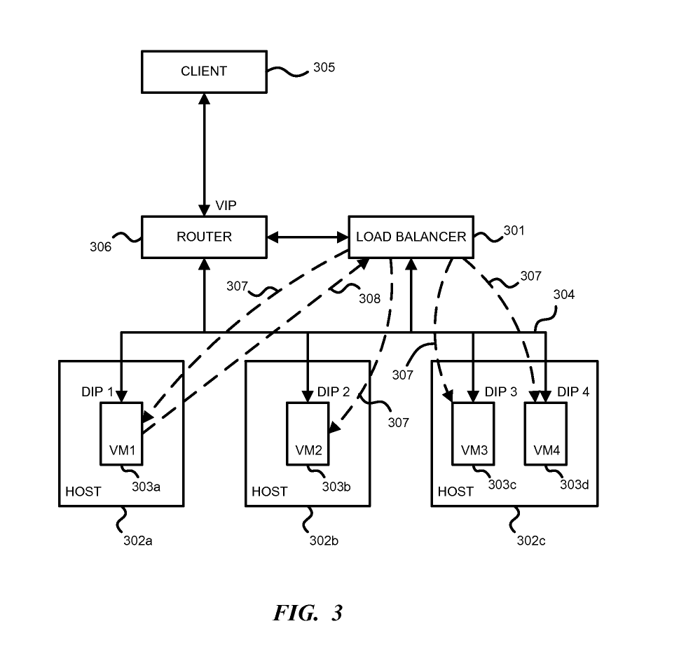

FIG. 3 illustrates an alternative embodiment of a failover cluster in which the load balancer 301 is not in the direct traffic path to the host servers 302 and VMs 303. Traffic from client 305 is sent to the VIP for the subscriber's application, which is supported by one of the VMs 303. The VIP is assigned to router 306, so the traffic from client 305 is routed to router 306. A mapping is maintained by router 306, which associates the VIP with the DIP for the VM 303 that supports the application. Router 306 directs the packets for the VIP to the DIP for the VM 303 that is hosting the application.

Load balancer 301 may be used to identify and track which VM 303 is supporting the subscriber's application. However, rather than route the VIP packets to that VM 303, load balancer 301 provides instructions, information or commands to router 306 to direct the VIP packets.

Load balancer 301 sends health probes 307 to the VMs 303. Health probes 307 may request health status information and may contain information, such as the identification of the VM 303 that the load balancer 301 believes is supporting the subscriber application. Health probes 307 may also notify the VMs 303 that a new VM is needed to host the application. The VMs may respond to provide health status information and to confirm that they are or are not currently supporting the application. In one embodiment, the active VM1 303a that is supporting the application sends message 308 to notify the load balancer 301 that it has responsibility for the application. Load balancer 301 then directs the router 306 to send all VIP packets to DIPJ for VM 1.

The VMs 303 may communicate with each other directly to determine which VM 303 should take responsibility for the application and respond affirmatively to a health probe message. Alternatively, if a health probe indicates that no VM 303 has responded that it has responsibility for the subscriber application, then one of the VMs 303 may send a response to the load balancer 301 to take responsibility for the application.

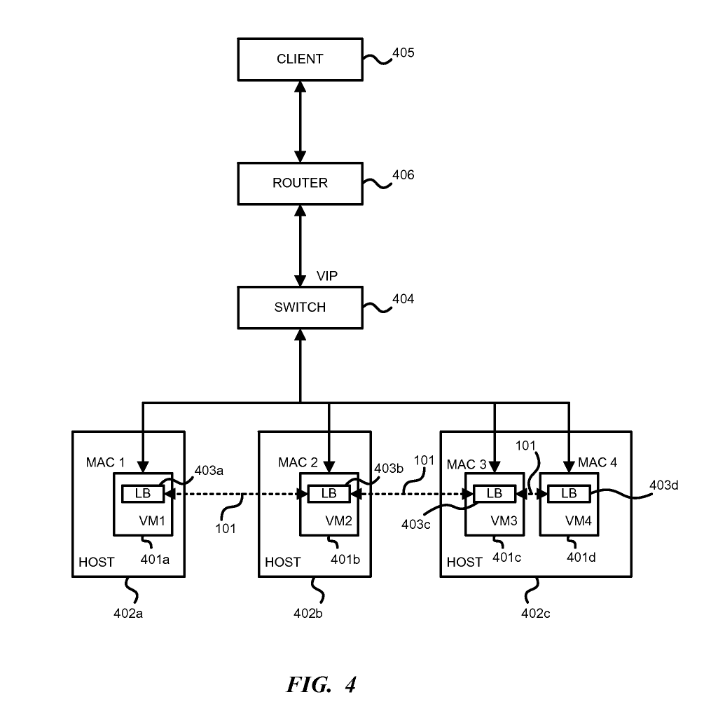

FIG. 4 illustrates a failover cluster using network load balancing distributed across multiple nodes according to a one embodiment. One or more VMs 401 run on host servers 402. Load balancing (LB) modules 403 run on each VM 401 and communicate with each other to monitor the health of each VM 401 and to identify which VM 401 is being used to support the subscriber's application. Distributed LB modules 403 may exchange health status messages periodically or upon the occurrence of certain events, such as the failure of a VM 401 or host 402. LB modules 403 may be located in a host partition or in a VM 401.

The system illustrated in FIG. 4 is not limited to using a VIP:DIP mapping to route packets to the application. Each of the VMs 401 may be associated with a unique Media Access Control (MAC) address that switch 404 uses to route packets. Client 405 sends packets to the VIP for the subscriber application and router 406 directs the packets to switch 404, which may be associated with the VIP for routing purposes. Switch 404 then forwards the packets to all of the VMs 401, which each has the VIP in its stack. LB modules 403 communicate with each other to identify which VM 401 should process the VIP packets. The VMs that do not have responsibility for the application either drop or ignore the VIP packets from switch 404.

Embodiments of the invention convert a traditional load balancing service from distributing an application across multiple VMs to using only one VM at a time for the application. The load balancer uses health probes to monitor the VMs assigned to an application. The load balancer actively responds to responses from the health probes on the fly and reroutes or switches an application to a new VM when a hosting VM fails. In this way, the load balancer may direct traffic associated with an application using its VIP. The VMs and load balancer do not require special permissions or access to implement the embodiments described herein. Furthermore, the load balancer does not need to be reprogrammed or otherwise modified and special APIs are not needed to implement this service. Instead, any VM or host involved with a particular subscriber application only needs to respond to the load balancer's health probes to affect the flow of the packets.

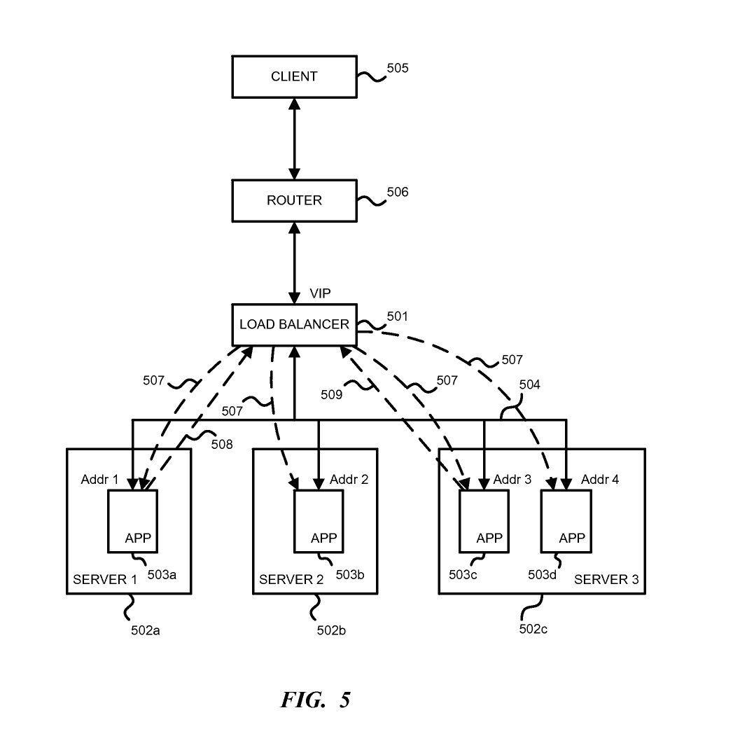

The invention disclosed herein is not limited to use with virtual machines in an IaaS or cloud computing environment. Instead, the techniques described herein may be used in any load balancing system or failover cluster. For example, FIG. 5 illustrates a load balancer 501 hosting a VIP in failover cluster in a local area network (LAN) embodiment. Host servers 502 may support one or more instances of an application (APP) 503. Each of the instances of the application 503 is associated with an address (Addr). The address may be uniquely associated with the application 503 or may be assigned to the server 502. In one embodiment, only one of the servers 502 is actively supporting the application at any time. The other servers 503 are in a standby or backup mode and do not respond to any traffic directed to the application.

A VIP address is associated with the application and is exposed as an endpoint to clients 505 at a load balancer 501. Servers 502 and load balancer 501 communicate over local area network 504. Load balancer 501 issues health probe messages 507 to all of the servers 502. The server 502a that is currently supporting the application instance 503a responds with a health status message 508 that acknowledges ownership of the application 503a. Other servers, such as server 503c, may respond to the health probe message 507 with a negative health message 509 that notifies load balancer 501 that it is not currently supporting the application. Alternatively, the load balancer knows that servers 503b-d are not the active host, if they do not send any response to the health probe.

Packets addressed to the application's VIP from client 505 are routed through one or more routers 506 to load balancer 501, which then forwards the packets to application instance 503a on server 502a.

If server 503a fails, then a backup server 503c may take over the subscriber application. Server 503c may issue a health response message 509 to load balancer 501 proactively upon observing that server 503a has not responded to a routine health probe 507. Alternatively, if health probe 507 that indicates that the application 503 is not currently supported by any server, then server 503c may issue response message 509 claiming responsibility for the application 503. Once the new server 503c takes over the application, load balancer 501 routes incoming VIP packets to server 503c. The other, inactive servers 503 may observe VIP packets on LAN 504, but they ignore these packets because they are not currently assigned to host the active application instance.

Applications 503 or servers 502 may add the VIP and/or DIP addresses to the server's stack for use by the application. In one embodiment, each of the servers 502 or applications 503 are assigned a unique DIP. The VIP is also added to the operating system on the server 502 where the application 503 is currently hosted so that the applications can bind to the VIP, which allows the server to send and receive traffic using the VIP. When the server 502a operating system has the VIP address, then the application 503a may bind to the VIP and may respond directly to client 505 without passing back through load balancer 501. This allows the application 503a to use direct server return to send packets to the client 505 while having the proper source VIP address in the packets. Similarly, the operating systems for the other servers 502 may have both the VIP and DIP addresses, which allows applications on any of the servers to use direct server return.

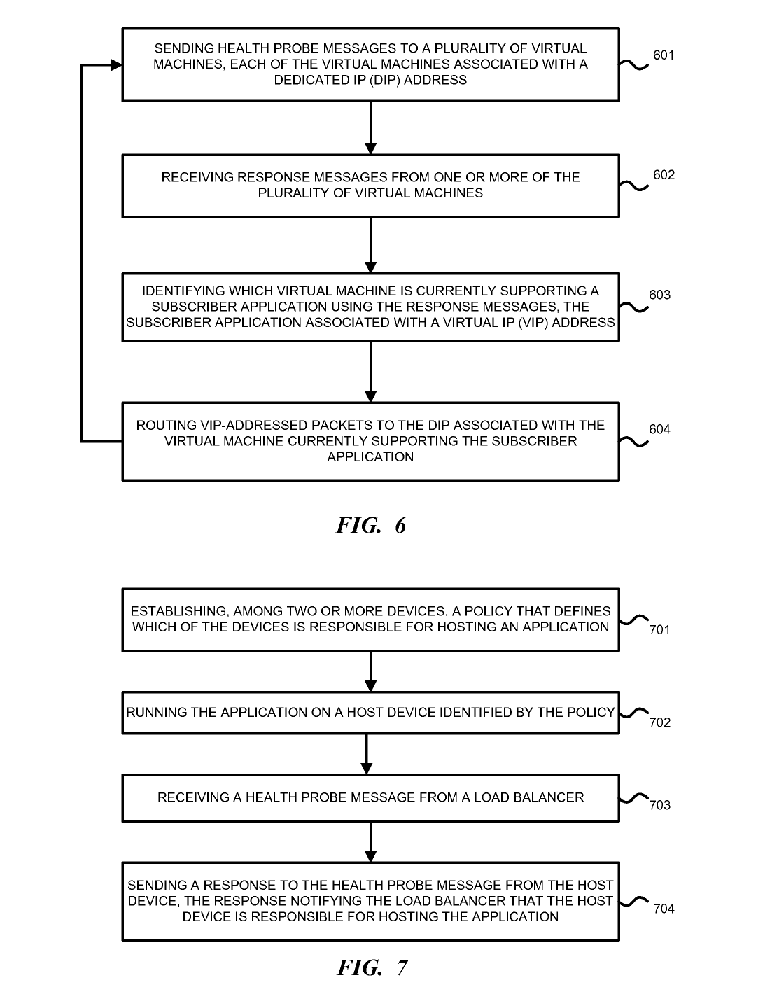

FIG. 6 is a flowchart illustrating a process for routing packets in a failover cluster according to one embodiment. In step 601, health probe messages are sent to a plurality of virtual machines. The health probe messages may be sent by a load balancer in one embodiment. Each of the virtual machines is associated with a DIP address. In step 602, response messages are received from one or more of the plurality of virtual machines. The response messages may include health status information for the virtual machine. In step 603, a virtual machine that is currently supporting a subscriber application is identified using the response messages. The subscriber application is associated with a VIP address. In one embodiment, the virtual machine that is supporting the subscriber application includes that information in a response message sent in step 602. In step 604, VIP-addressed packets that are associated with the subscriber application are routed to the DIP address associated with the virtual machine that is currently supporting the subscriber application.

The process continues by looping back to step 601, where additional health probe messages are sent. If the original virtual machine fails, then in step 602 it may send a response that requests a new host for the application. Another virtual machine may then take responsibility for the application by sending an appropriate response in step 602. Alternatively, the failed virtual machine may be unable to send a response in step 602 and another virtual machine may take responsibility for the application upon determining that no other virtual machine has indicated responsibility within a predetermined period. The new virtual machine is identified in step 603 and future packets for the VIP are forwarded to the new virtual machine via its DIP in step 604.

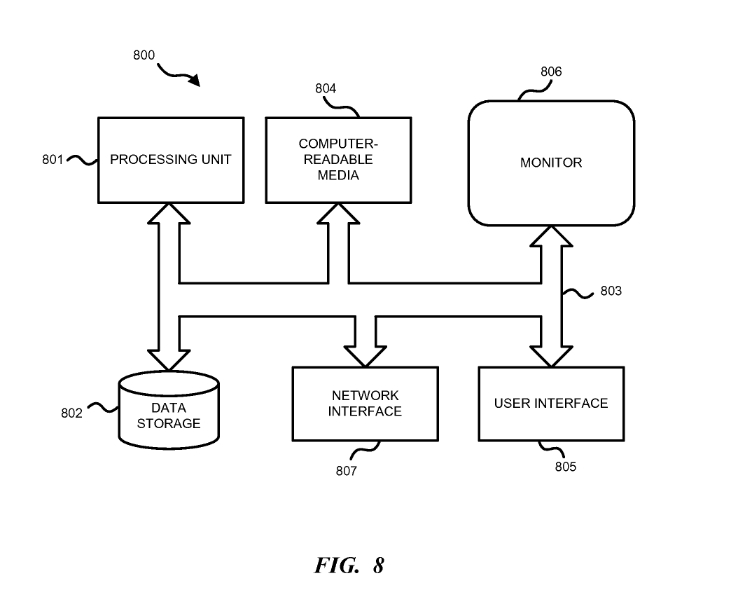

FIG. 7 is a flowchart illustrating a process for routing packets in a failover cluster according to another embodiment. In step 701, two or more devices establish a policy that defines which of the devices is responsible for hosting an application. The devices may be virtual machines in an IaaS or servers in a LAN, for example. In step 702, the application is run on a host device identified by the policy. In step 703, the device receives a health probe message from a load balancer. In step 704, the device sends a response to the health probe message from the host device. The response notifies the load balancer that the host device is responsible for and is actively hosting the application.

It will be understood that steps 601-604 of the process illustrated in FIG. 6 and steps 701-704 of the process illustrated in FIG. 7 may be executed simultaneously and/or sequentially. It will be further understood that each step may be performed in any order and may be performed once or repetitiously.

FIG. 8 illustrates an example of a suitable computing and networking environment 800 on which the examples of FIGS. 1-7 may be implemented. The computing system environment 800 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 8, an exemplary system for implementing various aspects of the invention may include a general purpose computing device in the form of a computer 800. Components may include, but are not limited to, processing unit 801, data storage 802, such as a system memory, and system bus 803 that couples various system components including the data storage 802 to the processing unit 801. The system bus 803 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 800 typically includes a variety of computer-readable media 804. Computer-readable media 804 may be any available media that can be accessed by the computer 801 and includes both volatile and nonvolatile media, and removable and non-removable media, but excludes propagated signals. By way of example, and not limitation, computer-readable media 804 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 800. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 802 includes computer storage media in the form of volatile and/or nonvolatile memory such as read only memory (ROM) and random access memory (RAM). A basic input/output system (BIOS), containing the basic routines that help to transfer information between elements within computer 800, such as during start-up, is typically stored in ROM. RAM typically contains data and/or program modules that are immediately accessible to and/or presently being operated on by processing unit 801. By way of example, and not limitation, data storage 802 holds an operating system, application programs, and other program modules and program data.

Data storage 802 may also include other removable/non-removable, volatile/nonvolatile computer storage media. By way of example only, data storage 802 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 8, provide storage of computer-readable instructions, data structures, program modules and other data for the computer 800.

A user may enter commands and information through a user interface 805 or other input devices such as a tablet, electronic digitizer, a microphone, keyboard, and/or pointing device, commonly referred to as mouse, trackball or touch pad. Other input devices may include a joystick, game pad, satellite dish, scanner, or the like. These and other input devices are often connected to the processing unit 801 through a user input interface 805 that is coupled to the system bus 803, but may be connected by other interface and bus structures, such as a parallel port, game port or a universal serial bus (USB). A monitor 806 or other type of display device is also connected to the system bus 803 via an interface, such as a video interface. The monitor 806 may also be integrated with a touch-screen panel or the like. Note that the monitor and/or touch screen panel can be physically coupled to a housing in which the computing device 800 is incorporated, such as in a tablet-type personal computer. In addition, computers such as the computing device 800 may also include other peripheral output devices such as speakers and printer, which may be connected through an output peripheral interface or the like.

The computer 800 may operate in a networked environment using logical connections 807 to one or more remote computers, such as a remote computer. The remote computer may be a personal computer, a server, a router, a network PC, a peer device or other common network node, and typically includes many or all of the elements described above relative to the computer 800. The logical connections depicted in FIG. 8 include one or more local area networks (LAN) and one or more wide area networks (WAN), but may also include other networks. Such networking environments are commonplace in offices, enterprise-wide computer networks, intranets and the Internet.

When used in a LAN networking environment, the computer 800 may be connected to a LAN through a network interface or adapter 807. When used in a WAN networking environment, the computer 800 typically includes a modem or other means for establishing communications over the WAN, such as the Internet. The modem, which may be internal or external, may be connected to the system bus 803 via the network interface 807 or other appropriate mechanism. A wireless networking component such as comprising an interface and antenna may be coupled through a suitable device such as an access point or peer computer to a WAN or LAN. In a networked environment, program modules depicted relative to the computer 800, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
sending health probe messages to a plurality of virtual machines, each of the virtual machines associated with a Dedicated IP (DIP) address;
receiving response messages from one or more of the plurality of virtual machines;
identifying which virtual machine is currently supporting a subscriber application using the response messages, the subscriber application associated with a Virtual IP (VIP) address; and
routing VIP-addressed packets to the DIP associated with the virtual machine currently supporting the subscriber application.

2. The method of claim 1, wherein a load balancer sends the health probe messages, receives the response messages, and routes the VIP-addressed packets to the DIP.

3. The method of claim 1, wherein a load balancer sends the health probe messages, receives the response messages, the method further comprising:
instructing a router how to route the VIP-addressed packets to the DIP.

4. The method of claim 1, wherein one or more response messages indicates that a virtual machine is responsible for the subscriber application.

5. The method of claim 1, wherein a plurality of virtual machines are currently supporting a distributed subscriber application, and wherein VIP-addressed packets are routed to the DIPs associated with each of the virtual machines currently supporting the distributed subscriber application.

6. A method, comprising:
establishing, among two or more devices, a policy that defines which of the devices is responsible for hosting an application;
running the application on a host device identified by the policy;
receiving a health probe message from a load balancer;
sending a response to the health probe message from the host device, the response notifying the load balancer that the host device is responsible for hosting the application.

7. The method of claim 6, wherein the devices are virtual machines.

8. The method of claim 7, further comprising:
determining that a responsible virtual machine should no longer be responsible for the application by means of direct communication between the virtual machines; and
sending an unrequested response to the load balancer, the unrequested response indicating responsibility for hosting the application.

9. The method of claim 6, further comprising:
determining from the health probe message that no response to the health probe message has been sent by another device.

10. The method of claim 6, wherein the health probe message from the load balancer identifies a device that is currently responsible for the application.

11. The method of claim 6, wherein the devices are servers in a local area network.

12. The method of claim 11, further comprising:
monitoring responses to the health probe message sent by other servers; and
evaluating whether to host an application based upon the other servers' responses to the health probe message.

13. The method of claim 11, further comprising:
determining that no response to the health probe message was sent by another server within a predetermined time; and
sending an unrequested response to the load balancer, the unrequested response indicating responsibility for the application.

14. A system comprising:
a load balancer exposing a Virtual IP (VIP) address to a network;
a plurality of virtual machines hosted on a plurality of servers, each of the virtual machines assigned an address and adapted to receive and respond to health probes from the load balancer; and
a mapping maintained by the load balancer, the mapping indicating a relationship between the VIP and one or more of the addresses;
wherein the load balancer routes packets directed to the VIP address to a virtual machine's address based upon the virtual machines' responses to the health probes.

15. The system of claim 14, wherein the addresses for the virtual machines are Dedicated IP (DIP) addresses.

16. The system of claim 14, wherein the addresses for the virtual machines are Media Access Control (MAC) addresses.

17. The method of claim 14, wherein the VIP address is configured as a local network interface address in the virtual machine currently handling traffic for the VIP address.

18. The system of claim 14, wherein the load balancer adapted to receive and redirect packets directed to the VIP address to a virtual machine's address.

19. The system of claim 14, further comprising:
a router coupled to the virtual machines and the load balancer; and
wherein the load balancer is commands the router to redirect packets directed to the VIP address to a virtual machine's address.

20. The system of claim 14, wherein the load balancer is a network load balancer comprising a plurality of software modules distributed across the virtual machines.
